(19) United States
(12) Patent Application Publication
(10) Pub. No.: US 2015/0124378 A1
(43) Pub. Date: May 7, 2015

(54) POWER SUPPLY SYSTEM AND RACK MOUNT APPARATUS

(71) Applicant: FUJITSU LIMITED, KAWASAKI-SHI (JP)

(72) Inventor: Tomoya Okkoso, Santa Clara, CA (US)

(21) Appl. No.: 14/519,330

(22) Filed: Oct. 21, 2014

(30) Foreign Application Priority Data
Nov. 7, 2013 (JP) 2013-231413

(51) Int. Cl. H02B 1/21

(52) U.S. Cl. CPC H02B 1/21
USPC 361/624; 361/637

(57) ABSTRACT

There is provided a power supply system including: a first busbar provided to extend in a predetermined direction on a first member, the first busbar being conductive and supplied with electricity; a second busbar provided to extend in the predetermined direction on a second member relatively movable with respect to the first member in the predetermined direction, the second busbar being conductive and spaced apart facing the first busbar; two rollers provided between the first busbar and the second busbar facing each other, the two rollers being aligned with respect to each other in the predetermined direction; and a belt configured to wind and rotate around the two rollers so as to contact with the first busbar and the second busbar with a surface contact thereof, the belt being conductive.

### CROSS-REFERENCE TO RELATED APPLICATION

This application is based upon and claims the benefit of priority of the prior Japanese Patent Application No. 2013-231413, filed on Nov. 7, 2013, the entire contents of which are incorporated herein by reference.

### FIELD

The embodiments discussed herein are related to a power supply system and a rack mount apparatus.

### BACKGROUND

As a form of mobile electrical apparatus that receives electric signals such as a control signal, Japanese Laid-open Utility Model Publication No. 01-77292 discusses a known signal transmission device that includes a mobile electrical apparatus that transmits and receives a control signal to and from a signal transmission conductor via a current collecting roller.

### SUMMARY

According to an aspect of the invention, a power supply system includes: a first busbar provided to extend in a predetermined direction on a first member, the first busbar being conductive and supplied with electricity; a second busbar provided to extend in the predetermined direction on a second member relatively movable with respect to the first member in the predetermined direction, the second busbar being conductive and spaced apart facing the first busbar; two rollers provided between the first busbar and the second busbar facing each other, the two rollers being aligned with respect to each other in the predetermined direction; and a belt configured to wind and rotate around the two rollers so as to contact with the first busbar and the second busbar with a surface contact thereof, the belt being conductive.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating a device according to a first embodiment;

FIG. 2 is a perspective view of the device illustrated in FIG. 1, which illustrates a state in which the tray is drawn out;

FIG. 3 is a perspective view of an example in which the device is mounted in a rack;

FIG. 4 is an exploded perspective view illustrating a power supply system according to an embodiment;

FIG. 5 is a perspective view illustrating the power supply system in an assembled state;

FIG. 6 illustrates three orthographic views of a relay mechanism;

FIG. 7 is a perspective view of components of the relay mechanism that have been picked out;

FIG. 8 is a diagram illustrating an exemplary state in which a first busbar is mounted in a housing;

FIG. 9 is a diagram illustrating an exemplary state in which the relay mechanism is mounted in the housing;

FIG. 10 is an enlarged view of portion X of FIG. 9;

FIG. 11 is a perspective view illustrating an exemplary state seen from the front side in which a second busbar is mounted to the tray;

FIG. 12 is a perspective view illustrating an exemplary state seen from the rear side in which the second busbar is mounted to the tray;

FIGS. 13A and 13B are each a diagram illustrating the manner in which the relay mechanism is connected to each of the first busbar and the second busbar;

FIGS. 14A and 14B are each a top view illustrating the manner in which the relay mechanism moves upon movement of the tray;

FIG. 15 is a perspective view illustrating a device according to a second embodiment;

FIG. 16 is a perspective view of the device illustrated in FIG. 15, which illustrates a state in which the tray is drawn out;

FIG. 17 is an exploded perspective view illustrating a power supply system according to the second embodiment;

FIGS. 18A and 18B are diagrams each illustrating an exemplary state in which a first busbar is mounted in the housing;

FIGS. 19A and 19B are perspective views each illustrating an exemplary state seen from the front side in which a second busbar is mounted to the tray;

FIG. 20 is a perspective view illustrating an exemplary state seen from the rear side in which the second busbar is mounted to the tray;

FIG. 21 illustrates three orthographic views of a relay mechanism;

FIG. 22 is a perspective view of components of the relay mechanism that have been picked out;

FIGS. 23A and 23B are each a diagram illustrating connection portions between the relay mechanism and each of the first busbar and the second busbar;

FIGS. 24A and 24B are each a top view illustrating the manner in which the relay mechanism moves upon movement of the tray; and

FIG. 25 is an explanatory drawing of a protective cover and a protective flange of the tray.

### DESCRIPTION OF EMBODIMENTS

In the configuration described in BACKGROUND, the current collecting roller and the signal transmission conductor are in line contact with each other; accordingly, when the configuration is applied to a power supply system, since the contact area is small, the contact resistance becomes high making it difficult to distribute a high current.

Hereinafter, embodiments of a power supply system and a rack mount apparatus that are capable of supplying electric power in a stable and efficient manner will be described in detail with reference to the accompanying drawings.

### First Embodiment

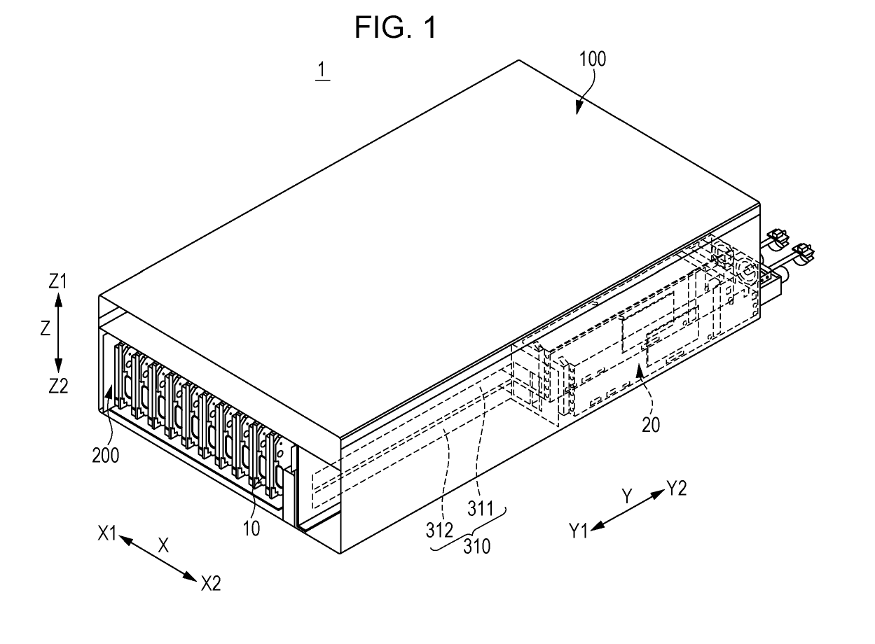

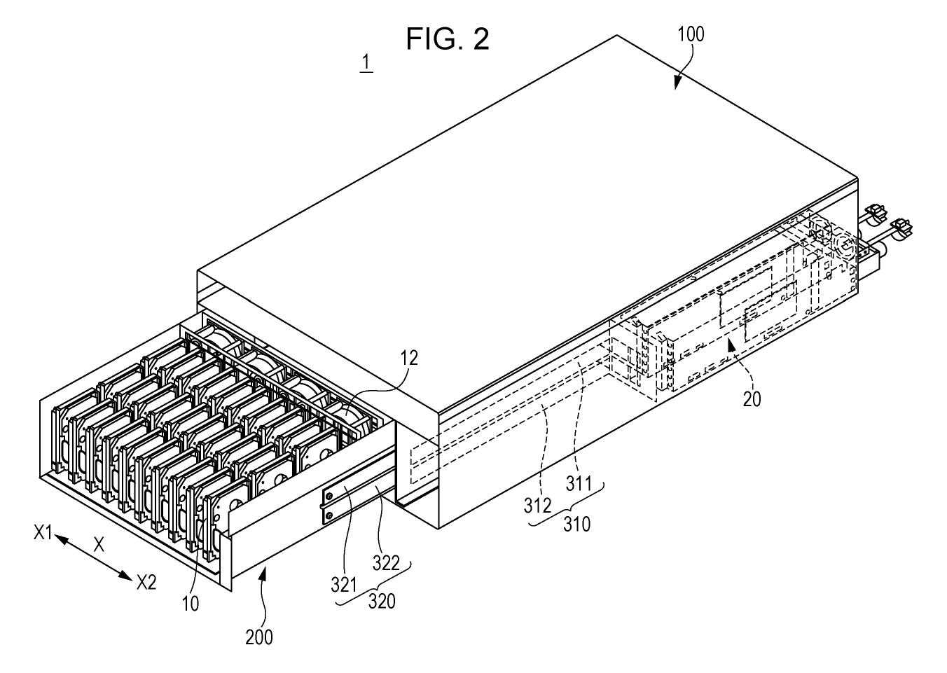

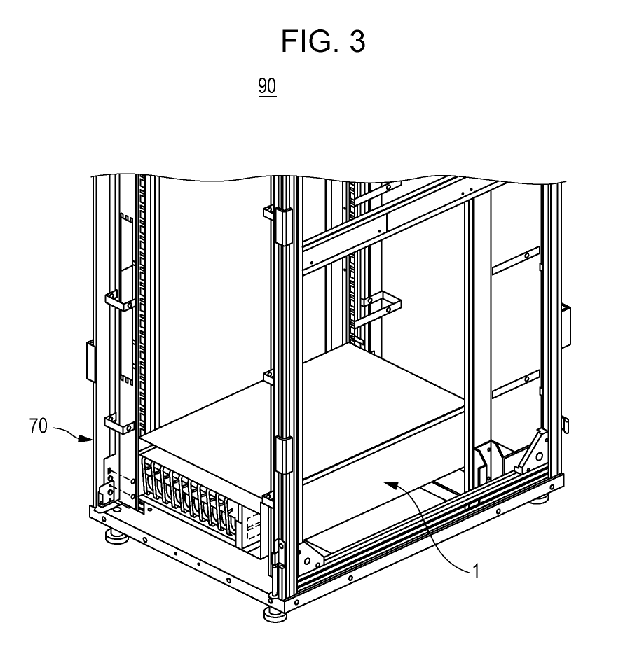

FIG. 1 is a perspective view illustrating a device 1 according to the first embodiment. FIG. 2 is a perspective view of the device 1 illustrated in FIG. 1, which illustrates a state in which a tray 200 is drawn out. FIG. 3 is a perspective view of an example in which the device is mounted in a rack.

In FIGS. 1 and 2, a portion of the interior of the device 1 is illustrated in a transparent view depicted with dotted lines. Note that in the following description, in order to facilitate the description, the Y1 side of FIG. 1 in the Y direction is the front side of the device 1 and the Y2 side is the rear side of the device 1. Furthermore, the Z1 side of FIG. 1 in the Z direction is the upper side of the device 1 and the Z2 side is the lower side of the device 1.

The device 1 is mounted in a rack 70 as illustrated in FIG. 3, and the rack 70 is able to mount a plurality of devices 1.

As illustrated in FIGS. 1 and 2, the device 1 includes a housing 100 (an example of a first member) and the tray 200 (an example of a second member). The tray 200 may be drawn out from or pushed into the housing 100 by being translated in the Y direction with respect to the housing 100. FIG. 1 illustrates a state in which the housing 100 is housed in (pushed in) the tray 200 and FIG. 2 illustrates a state in which the housing 100 is drawn out from the tray 200.

The housing 100 takes a form of a case and houses therein the tray 200 and electronic components mounted on the tray 200. The housing 100 is fixed to the rack 70. Accordingly, the housing 100 is an element of the rack 70. As illustrated in FIGS. 1 and 2, a single housing 100 may house a single tray 200 or may house a plurality of trays 200. The front side of the housing 100 is open. The tray 200 may be drawn out or pushed in through the front side of the housing 100 by being translated in the Y direction with respect to the housing 100. Note that the lateral sides of the housing 100 may be closed and the rear side may be open or closed.

As schematically illustrated with the dotted lines in FIGS. 1 and 2, the housing 100 may be equipped with a power source 20. In the examples illustrated in FIGS. 1 and 2, the power source 20 takes a form of a power supply unit (PSU). The power source 20 may be mounted inside any portion of the housing 100 and, as illustrated in FIGS. 1 and 2, may be mounted inside the housing 100 on the rear lateral side. Note that the power source 20 may be mounted inside the rack 70 and outside of the housing 100, alternatively, the power source 20 may be mounted outside the rack 70.

Various electronic components according to the function of the device 1 are mounted on the tray 200. The various electronic components typically include hot-swap parts. Hot-swap parts are, for example, parts and electronic equipment that are in an active state (operating state) up to the point when the parts and the electronic equipment are removed for replacement (hot-swap). The hot-swap parts may include, for example, a hard disk drive, a fan, a Peripheral Component Interconnect (PCI) cassette, and a memory. Furthermore, the tray 200 may take a form of a blade server in which the entire tray 200 is a hot-swap part. In the examples illustrated in FIGS. 1 and 2, a plurality of hard disk drives 10 and a plurality of fans 12 are mounted on the tray 200, as examples of the hot-swap parts.

Note that as described above, the tray 200 may be drawn out from the housing 100. When the tray 200 is drawn out, an operator may access not only the hot-swap parts on the front side of the tray 200 (the hard disk drives 10, for example) but also the hot-swap parts on the rear side (the fans 12, for example). Accordingly, during maintenance work, the operator may draw out the tray 200 and gain access to any of the hot-swap parts. With only the space on the front side of the housing 100, the number of hot-swap parts that may be mounted will be limited; however, by providing the drawer type tray 200, more hot-swap parts may be mounted in the housing 100.

An example of the power supply system of the device 1 will be described next.

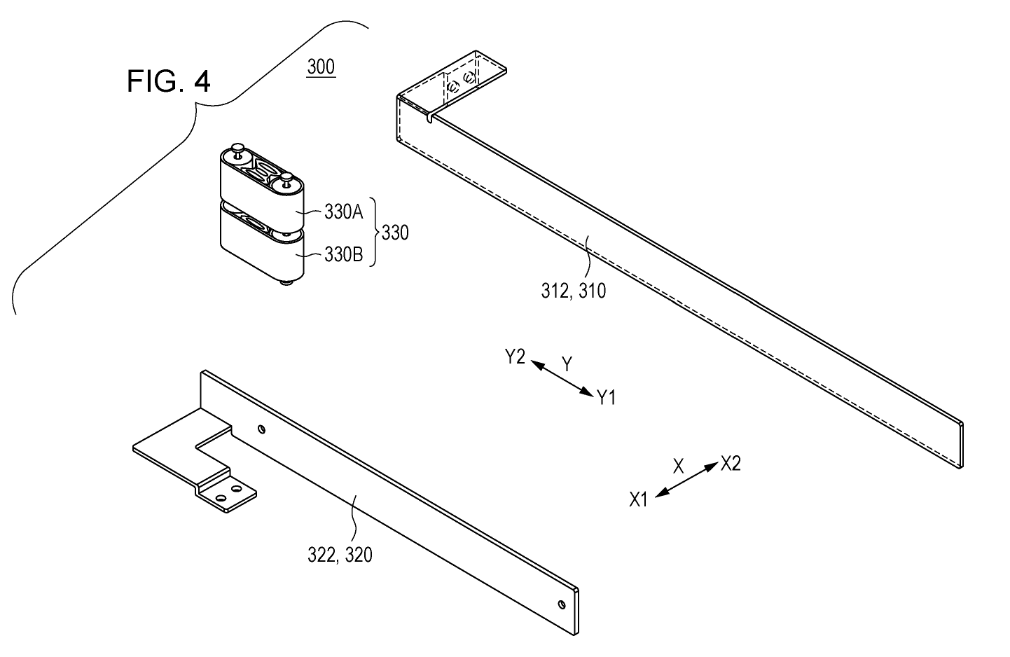

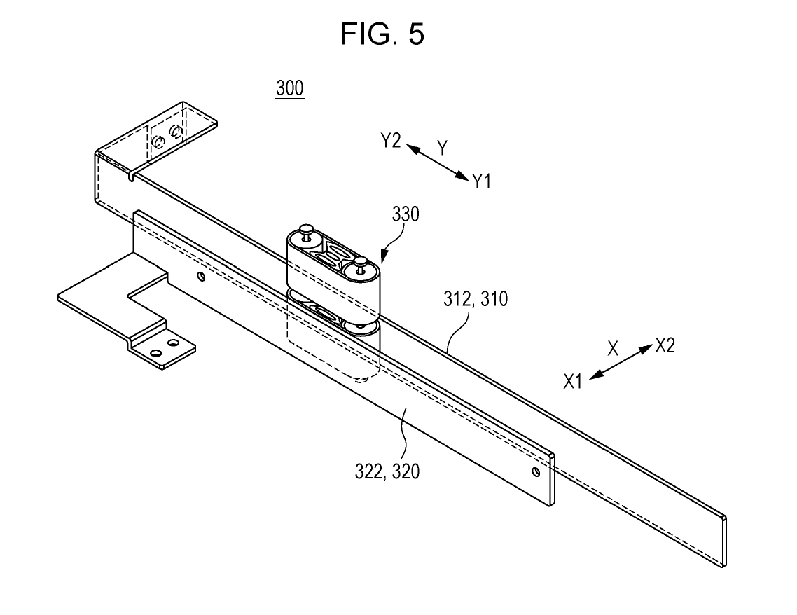

FIG. 4 is an exploded perspective view illustrating a power supply system 300 according to an embodiment. FIG. 5 is a perspective view illustrating the power supply system 300 in an assembled state. Note that a portion of a first busbar 310 and a portion of a second busbar 320, more specifically, for example, a first busbar 311 on the upper side and a second busbar 321 on the upper side, respectively, are not shown in FIGS. 4 and 5 in order to facilitate visual understanding.

As illustrated in FIGS. 4 and 5, the power supply system 300 includes the first busbar 310, the second busbar 320, and a relay mechanism 330.

In the present embodiment, the first busbar 310 includes, as illustrated in FIG. 1, the first busbar 311 on the upper side and a first busbar 312 on the lower side and the second busbar 320 includes, as illustrated in FIG. 2, the second busbar 321 on the upper side and a second busbar 322 on the lower side. Meanwhile, the relay mechanism 330 includes a relay mechanism 330A on the upper side and a relay mechanism 330B on the lower side in an integrated manner. The first busbar 311 on the upper side, the second busbar 321 and the upper side, and the relay mechanism 330A on the upper side are provided for a ground voltage, for example. The first busbar 312 on the lower side, the second busbar 322 on the lower side, and the relay mechanism 330B on the lower side are provided for a source voltage, for example. That is, the power supply system 300 integrally includes a mechanism that separately supplies a ground voltage and a source voltage for supplying electric power from the power source 20 to the hot-swap parts on the tray 200. However, a mechanism that supplies the ground voltage and a mechanism that supplies the source voltage may be provided in the power supply system 300 in a separate manner. Furthermore, the power supply system 300 may only include the mechanism that supplies the source voltage, and another component may be adopted as for the mechanism that supplies the ground voltage.

The first busbar 310 is formed of a conductive material such as a conductor metal (copper, for example). Different from a cable, the first busbar 310 typically includes a planar contact surface (a surface described later that is in contact with a belt 336). Corresponding to the direction in which the tray 200 is drawn out, the first busbar 310 extends in the Y direction. When the line normal to the first busbar 310 extends in the X direction, the contact surface of the first busbar 310 is formed on the X1 side of the first busbar 310. Note that as described above and as illustrated in FIGS. 1 and 2, the first busbar 310 may include the first busbar 311 on the upper side and the first busbar 312 on the lower side. In such a case, the first busbar 311 on the upper side and the first busbar 312 on the lower side are electrically insulated with each other.

The second busbar 320 is formed of a conductive material such as a conductor metal (copper, for example). Different from a cable, the second busbar 320 typically includes a planar contact surface (a surface described later that is in contact with the belt 336). Corresponding to the direction in which the tray 200 is drawn out, the second busbar 320 extends in the Y direction. When the line normal to the second busbar 320 extends in the X direction, the contact surface of the second busbar 320 is formed on the X2 side of the second busbar 320. The contact surface of the second busbar 320 is spaced apart from and faces the contact surface of the first busbar 310 in the X direction. A width (a length in the Z direction) of the contact surface of the second busbar 320 may be the same as a width of the contact surface of the first busbar 310. Note that the second busbar 320 is preferably provided at the same position as the first busbar 310 in the Z direction. Note that as described above and as illustrated in FIG. 2, the second busbar 320 may include the second busbar 321 on the upper side and the second busbar 322 on the lower side. In such a case, the second busbar 321 on the upper side and the second busbar 322 on the lower side are electrically insulated with each other.

The relay mechanism 330 is provided between the first busbar 310 and the second busbar 320 in the X direction and relays the electrical connection between the first busbar 310 and the second busbar 320. In other words, the relay mechanism 330 electrically connects the first busbar 310 to the second busbar 320. Note that as described above and as illustrated in FIGS. 4 and 5, the relay mechanism 330 may include the relay mechanism 330A on the upper side and the relay mechanism 330B on the lower side. In such a case, the relay mechanism 330A on the upper side and the relay mechanism 330B on the lower side are electrically insulated with each other.

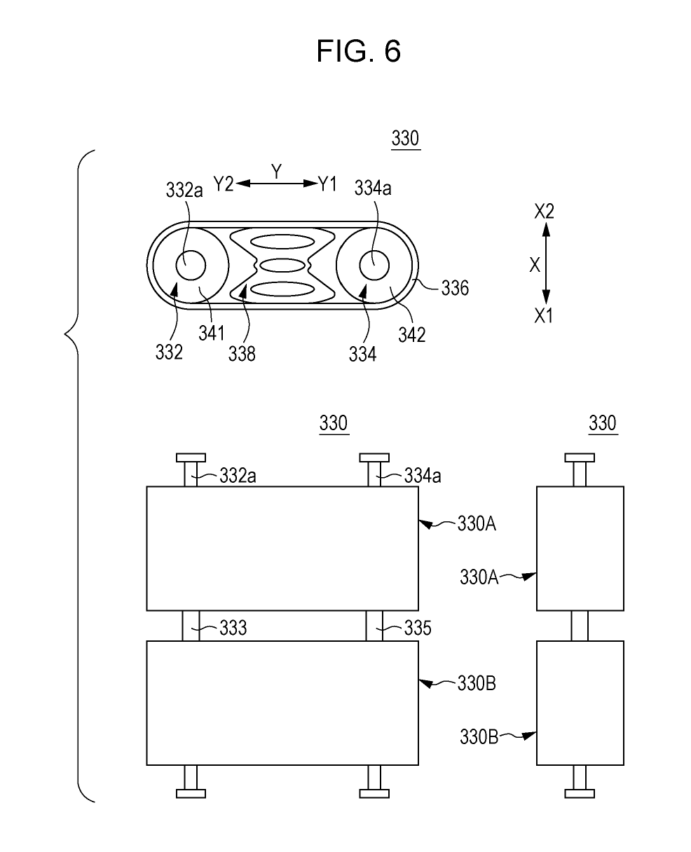

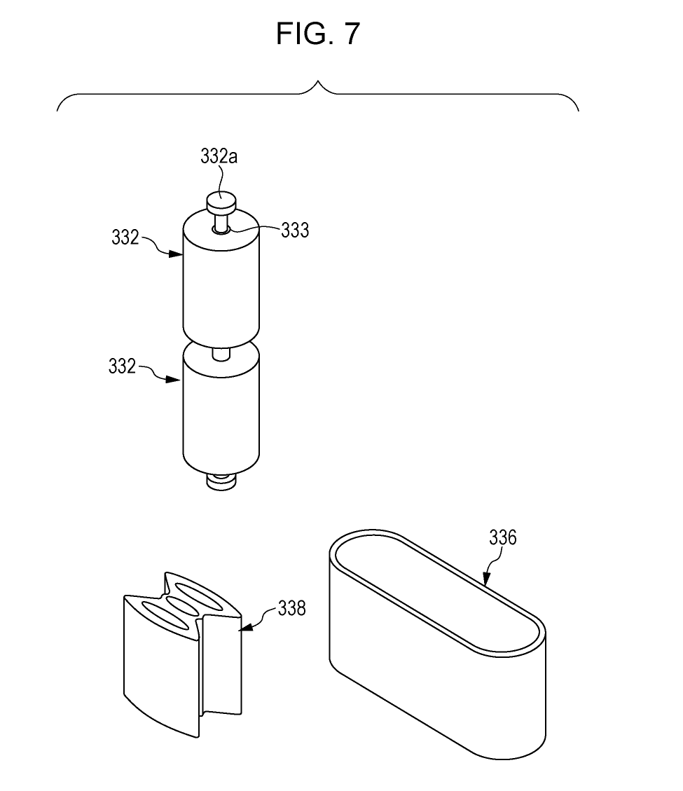

FIG. 6 illustrates three orthographic views of the relay mechanism 330. FIG. 7 is a perspective view of components of the relay mechanism 330 that have been picked out. Note that among first rollers 332 and second rollers 334, only the first rollers 332 are illustrated in FIG. 7 as a representative example. Note that in the present embodiment, the relay mechanism 330 includes the relay mechanism 330A on the upper side and the relay mechanism 330B on the lower side as described above and the components of the relay mechanism 330A and those of the relay mechanism 330B are basically the same and the same reference numerals are attached thereto.

The relay mechanism 330A includes the first roller 332, the second roller 334, and the belt 336. Furthermore, the relay mechanism 330A preferably includes an elastic member 338 as illustrated in FIG. 6.

In a similar manner, the relay mechanism 330B includes the first roller 332, the second roller 334, and the belt 336. Furthermore, the relay mechanism 330B preferably includes the elastic member 338 as illustrated in FIG. 6.

The first rollers 332 are rotatable about a shaft portion 332a. The first rollers 332 each have a cylindrical shape with a predetermined height. The predetermined height is preferably slightly greater than a width (a length in the Z direction) of the belt 336. The first rollers 332 may be formed of any material such as resin or metal. The shaft portion 332a may be formed of resin, for example. As illustrated in FIGS. 6 and 7, a single shaft portion 332a that is shared by the upper and lower first rollers 332 may be provided. As illustrated in FIGS. 6 and 7, the shaft portion 332a may include an enlarged diameter portion at each of the upper and lower ends thereof. Note that a bearing 333 may be provided around the shaft portion 332a. Note that when the first rollers 332 are formed of metal, the bearing 333 may be formed of an insulating material. Similar to the shaft portion 332a, a single bearing 333 that is shared by the upper and lower first rollers 332 may be provided. Furthermore, when the first rollers 332 are formed of a nonconductive material such as resin and when electrical insulation between each first roller 332 and the corresponding belt 336 is secured, a single first roller 332 that is shared by the upper and lower relay mechanisms 330A and 330B may be provided.

Similarly, the second rollers 334 are rotatable about a shaft portion 334a. The second rollers 334 each have a cylindrical shape with a predetermined height (a length in the Z direction). The predetermined height is preferably slightly greater than the width (the length in the Z direction) of the belt 336. The outer diameter of each second roller 334 may be the same as the outer diameter of each first roller 332. The second rollers 334 may be formed of any material such as resin or metal. The shaft portion 334a may be formed of resin, for example. As illustrated in FIGS. 6 and 7, a single shaft portion 334a that is shared by the upper and lower second rollers 334 may be provided. As illustrated in FIGS. 6 and 7, the shaft portion 334a may include an enlarged diameter portion at each of the upper and lower ends thereof. Note that a bearing 335 may be provided around the shaft portion 334a. Note that when the second rollers 334 are formed of metal, the bearing 335 may be formed of an insulating material. Similar to the shaft portion 334a, a single bearing 335 that is shared by the upper and lower second rollers 334 may be provided. Furthermore, when the second rollers 334 are formed of a nonconductive material such as resin and when the electrical insulation between each second roller 334 and the corresponding belt 336 is secured, a single second roller 334 that is shared by the upper and lower relay mechanisms 330A and 330B may be provided.

The first rollers 332 and the second rollers 334 are preferably aligned in the Y direction with respect to one another such that the linear portions (contact surfaces) of the belts 336 extend in the Y direction. In other words, a line connecting the rotation center of a first roller 332 and the rotation center of a corresponding second roller 334 is parallel to the Y direction.

The belts 336 are each formed of a conductive material, such as copper or conductive rubber. As illustrated in FIG. 6, each of the belts 336 is provided around the corresponding first roller 332 and second roller 334. The belts 336 are each an endless belt that is wound around (open belted) the corresponding first roller 332 and second roller 334. The belts 336 may each rotate the corresponding first roller 332 and second roller 334 while rotating around the corresponding first roller 332 and second roller 334. The width (the length in the Z direction) of each belt 336 substantially corresponds to the width (the length in the Z direction) of the first busbar 310 and the second busbar 320. The width of each belt 336 may be slightly smaller than those of the first busbar 310 and the second busbar 320.

The elastic members 338 are each formed of an elastic material such as rubber or soft resin (nylon elastomeric resin, for example). The elastic members 338 are each provided between the corresponding first roller 332 and second roller 334 in the Y direction. The elastic members 338 are each provided in a space formed on the inner peripheral surface side of the corresponding belt 336. The elastic members 338 each push the corresponding belt 336 towards the first busbar 310 and the second busbar 320. In other words, the elastic members 338 are each disposed on the inner peripheral surface side of the corresponding belt 336 in an elastically deformed manner and pushes the corresponding belt 336 towards the outside in the X direction (the X1 direction and the X2 direction, see FIG. 6). As will be described later, the outside in the X direction corresponds to directions that increase the contact force between the belts 336, and the first busbar 310 and the second busbar 320. The elastic members 338 may each take a form of a gasket or a cushion material that exerts the same elastic function as the elastic members 338. Note that in the example illustrated in FIGS. 6 and 7, the elastic members 338 are separately provided in the upper and lower relay mechanisms 330A and 330B; however, similar to the shaft portions 332a and 334a, a single elastic member 338 that is shared by the upper and lower relay mechanisms 330A and 330B may be provided.

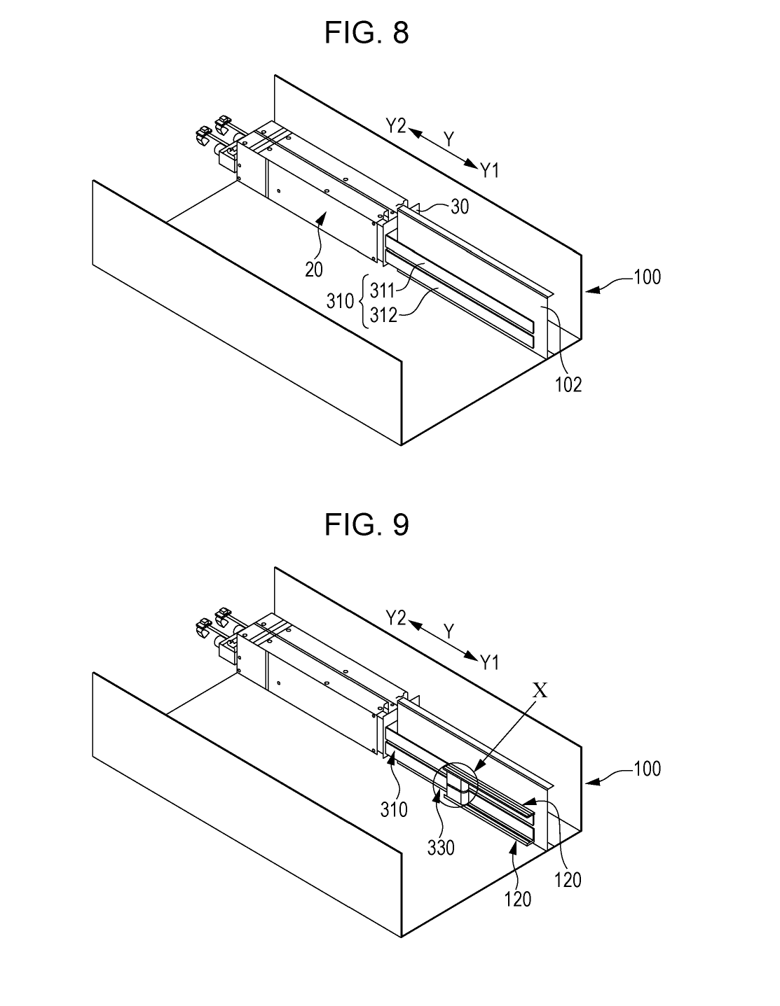

FIG. 8 is a diagram illustrating an exemplary state in which the first busbar 310 is mounted in the housing 100. Note that in FIG. 8, in order to facilitate the view of the interior, illustration of an upper surface member of the housing 100 is omitted.

The first busbar 310 is provided in the housing 100 so as to extend in the Y direction. The first busbar 310 may be fixed or supported with any method. For example, as illustrated in FIG. 8, the first busbar 310 may be fixed to a substrate 30 and a wall member 102 with a screw or the like. In such a case, the first busbar 310 may be electrically connected to the power source 20 through a circuit on the substrate 30. Note that the first busbar 310 may be directly connected to the power source 20 or may be connected to the power source 20 through another component such as a cable.

FIG. 9 is a diagram illustrating an exemplary state in which the relay mechanism 330 is mounted in the housing 100. FIG. 10 is an enlarged view of portion X of FIG. 9.

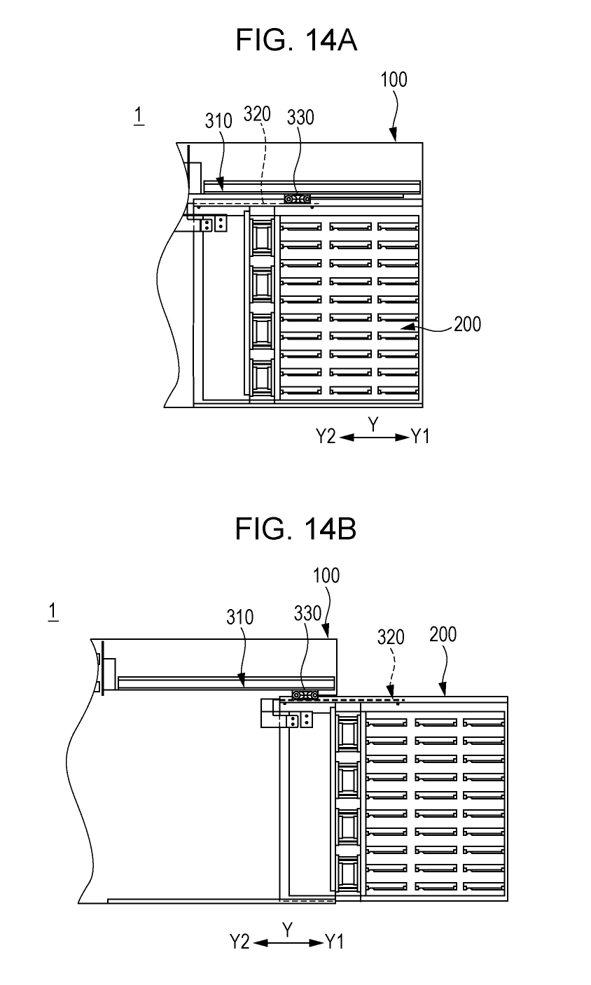

As illustrated in FIG. 9, the relay mechanism 330 may be mounted in the housing 100 with a pair of guide rails 120. In the examples illustrated in FIGS. 9 and 10, the guide rails 120 are each provided above and below the relay mechanism 330. The guide rails 120 extend in the Y direction so as to correspond to the moving range of the relay mechanism 330 in the Y direction (see FIG. 14). The guide rails 120 may guide the movement of the relay mechanism 330 in the Y direction described later, which is caused upon movement of the tray 200 in the Y direction, in any manner. In the examples illustrated in FIGS. 9 and 10, the guide rails 120 include guide grooves 122 that extend in the Y direction. The shaft portions 332a and 334a of the relay mechanism 330 are passed through the guide grooves 122. In such a case, the end portions (the enlarged diameter portions) of the shaft portions 332a and 334a that are larger than the width (the length in the X direction) of the guide grooves 122 may function to position the relay mechanism 330 in the up-down direction with respect to the guide rails 120. The relay mechanism 330 may be moved (translated) in the Y direction by moving the shaft portions 332a and 334a along the guide grooves 122 in the Y direction.

Note that the guide rails 120 may be fixed to the housing 100 in any manner. The guide rails 120 may be, for example, fitted into or screwed to the housing 100. Furthermore, the guide rails 120 may be fixed to the housing 100 through the first busbar 310. For example, the upper and lower guide rails 120 may be integrally formed with the upper and lower first busbars 311 and 312, respectively. However, in such a case, in order to avoid the upper and lower first busbars 311 and 312 from becoming short-circuited to each other, the shaft portions 332a and 334a are provided to the upper and lower relay mechanisms 330A and 330B in a separate manner.

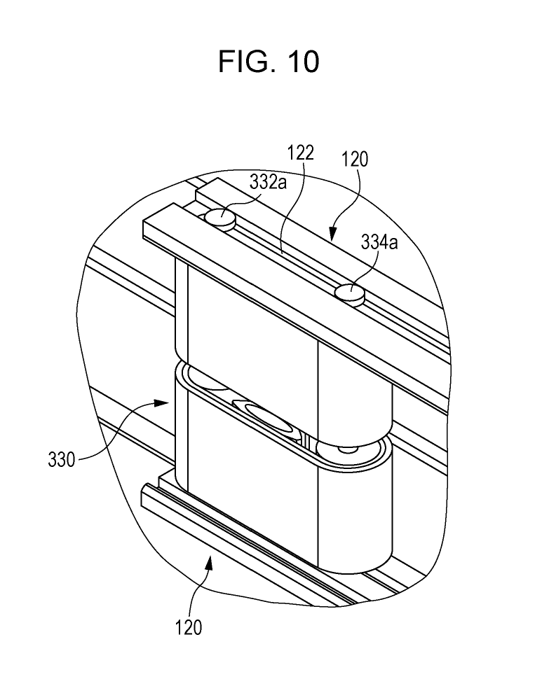

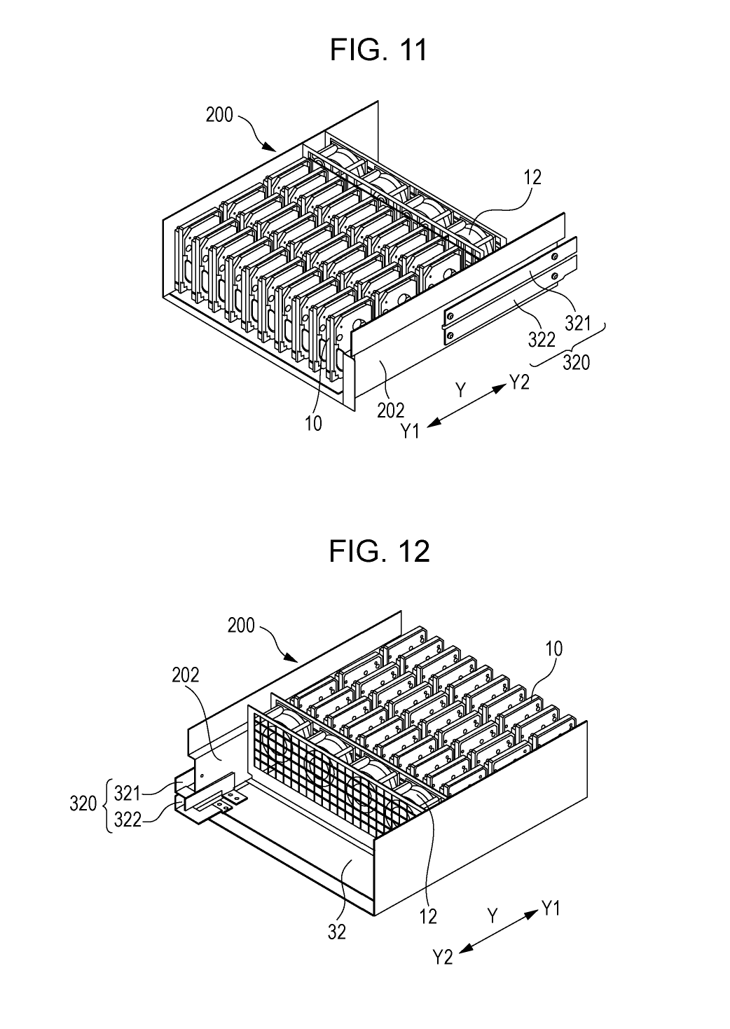

FIGS. 11 and 12 are each a perspective view illustrating an exemplary state in which the second busbar 320 is mounted to the tray 200. FIG. 11 is a perspective view seen from the front side and FIG. 12 is a perspective view seen from the rear side.

The second busbar 320 is provided to the tray 200 so as to correspond to the first busbar 310 and extends in the drawing-out direction (the Y direction) of the tray 200. The second busbar 320 is provided at a position that faces the first busbar 310 in the X direction (see FIGS. 1 and 2). The second busbar 320 may be fixed or supported with any method. For example, as illustrated in FIGS. 11 and 12, the second busbar 320 may be fixed to the substrate 32 and a wall member 202 with a screw or the like. In such a case, the second busbar 320 may be electrically connected to the hot-swap parts (for example, the hard disk drives 10 and the fans 12) on the tray 200 through a circuit on the substrate 32. Note that the second busbar 320 may be directly connected to the hot-swap parts on the tray 200 or may be connected to the hot-swap parts through another component such as a cable.

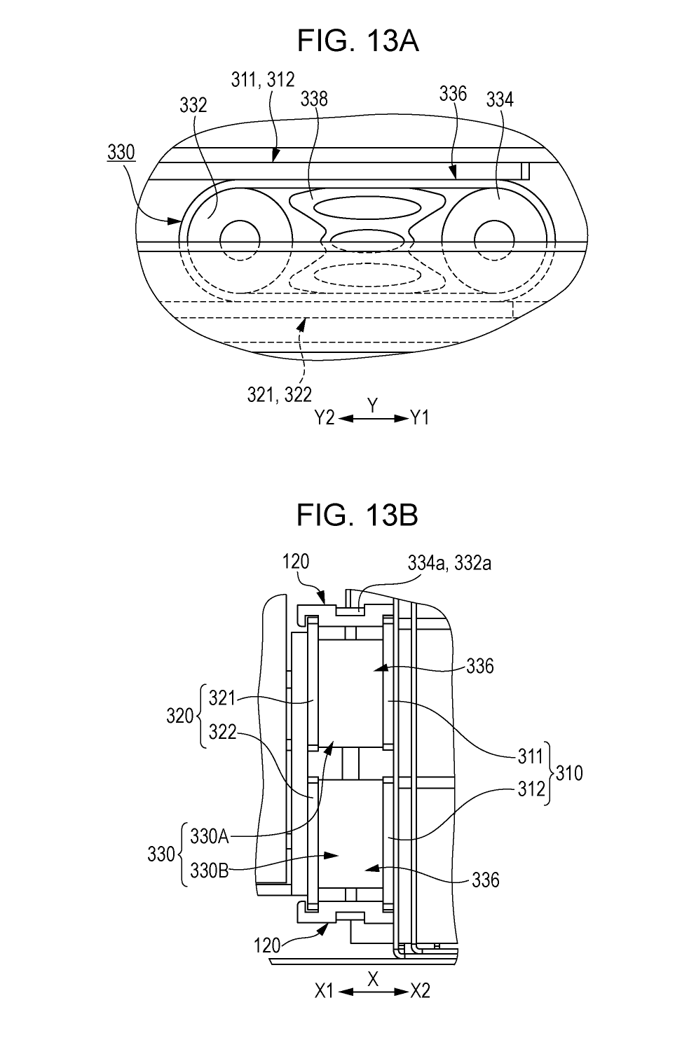

FIGS. 13A and 13B are each a diagram illustrating connection portions between the relay mechanism 330 and each of the first busbar 310 and the second busbar 320. FIG. 13A is a top view and FIG. 13B is a front view.

As illustrated in FIG. 13B, the relay mechanism 330 is disposed so that the belts 336 are in contact with both the first busbar 310 and the second busbar 320 in the X direction. In the above, as illustrated in FIG. 13A, the belts 336 are in surface contact with both the first busbar 310 and the second busbar 320. In other words, the belts 336 are each in surface contact with both the first busbar 310 and the second busbar 320 at sections of each belt 336 between the center of the corresponding first roller 332 and the center of the corresponding second roller 334 in the Y direction. Accordingly, the contact areas between the relay mechanism 330 and each of the first busbar 310 and the second busbar 320 may be increased in an efficient manner such that the relay mechanism 330 may relay electric power from the power source 20 to the tray 200 side in a stable and efficient manner. Note that each of the elastic members 338 preferably exerts an elastic force that reliably allows the relay mechanism 330 to come in contact with each of the first busbar 310 and the second busbar 320.

FIGS. 14A and 14B are each a top view illustrating the manner in which the relay mechanism 330 moves upon movement of the tray 200. FIG. 14A illustrates a state in which the tray 200 is housed in the housing 100 and FIG. 14B illustrates a state in which the tray 200 is drawn out from the housing 100. Note that in FIGS. 14A and 14B, in order to facilitate the view of the interior, illustration of the upper surface member of the housing 100 is omitted.

As illustrated in FIGS. 14A and 14B, when the tray 200 is drawn out from the housed state, the relay mechanism 330 moves in the Y2 direction with respect to the tray 200 and moves in the Y1 direction with respect to the housing 100. During the movement, the relay mechanism 330 maintains surface contact with the first busbar 310 and the second busbar 320. In other words, the relay mechanism 330 maintains surface contact with the first busbar 310 and the second busbar 320 throughout the section between where the tray 200 is totally stored and where the tray 200 is fully drawn out (that is, throughout the whole stroke). Accordingly, the supply of electric power from the power source 20 to the hot-swap parts on the tray 200 is maintained while the drawing-out operation of the tray 200 (during the movement of the relay mechanism 330) is carried out. Note that during the storing operation as well, the relay mechanism 330 moves while maintaining surface contact with the first busbar 310 and the second busbar 320 in a similar manner to the drawing-out operation.

During the movement of the relay mechanism 330, the belts 336 of the relay mechanism 330 rotate around the first rollers 332 and the second rollers 334 with the friction between the belts 336 and each of the first busbar 310 and the second busbar 320. In such a case, the belts 336 rotate around the first rollers 332 and the second rollers 334 while the friction generated between the belts 336, and the first rollers 332 and the second rollers 334 rotates the first rollers 332 and the second rollers 334 (see FIG. 6). In other words, while the belts 336 rotate around the first rollers 332 and the second rollers 334, the belts 336 relatively move with respect to the first busbar 310 and the second busbar 320 without any sliding against the first busbar 310 and the second busbar 320. Accordingly, wear of the belts 336, the first busbar 310, and the second busbar 320 due to the drawing-out and storing of the tray 200 may be reduced. Note that “without any sliding” does not imply that a slight sliding due to looseness (clearance) or tolerance is not tolerated. In other words, “without any sliding” implies that sliding that actually creates wear of the belts 336, the first busbar 310, and the second busbar 320 does not occur.

As described above, according to the present embodiment, the belts 336 of the relay mechanism 330 maintains surface contact with the first busbar 310 and the second busbar 320 during the drawing-out and storing operation of the tray 200. Accordingly, electric power from the power source 20 may be supplied to the hot-swap parts in a stable and efficient manner even during the drawing-out and storing operation of the tray 200. Specifically, since the portions between the belts 336 and each of the first busbar 310 and the second busbar 320 are in surface contact with each other, compared with a case in which the portions are in line contact with each other, the possibility of separation between the belts 336 and each of the first busbar 310 and the second busbar 320 due to disturbance such as vibration is small. Accordingly, electric power may be supplied in a stable manner. Furthermore, since the portions between the belts 336 and each of the first busbar 310 and the second busbar 320 are in surface contact with each other, compared with a case in which the portions are in line contact with each other, the contact area is larger (accordingly, the contact resistance is smaller) and electric power may be supplied in an efficient manner.

Furthermore, according to the present embodiment, during the drawing-out and storing operation of the tray 200, the belts 336 rotate around the first rollers 332 and the second rollers 334 without sliding against the first busbar 310 and the second busbar 320. Accordingly, wear of the belts 336, the first busbar 310, and the second busbar 320 due to the drawing-out and storing of the tray 200 may be reduced.

### Second Embodiment

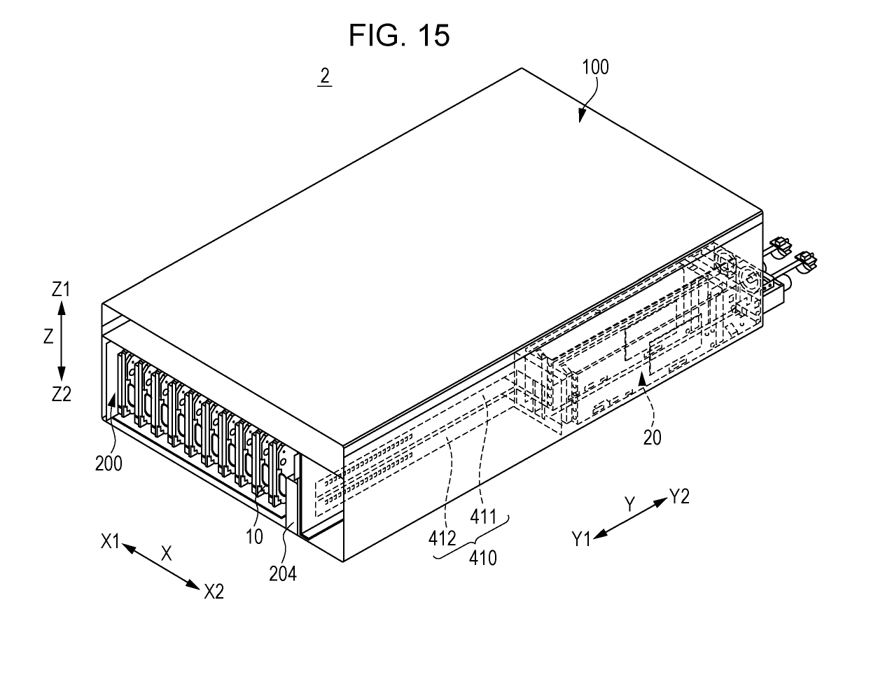

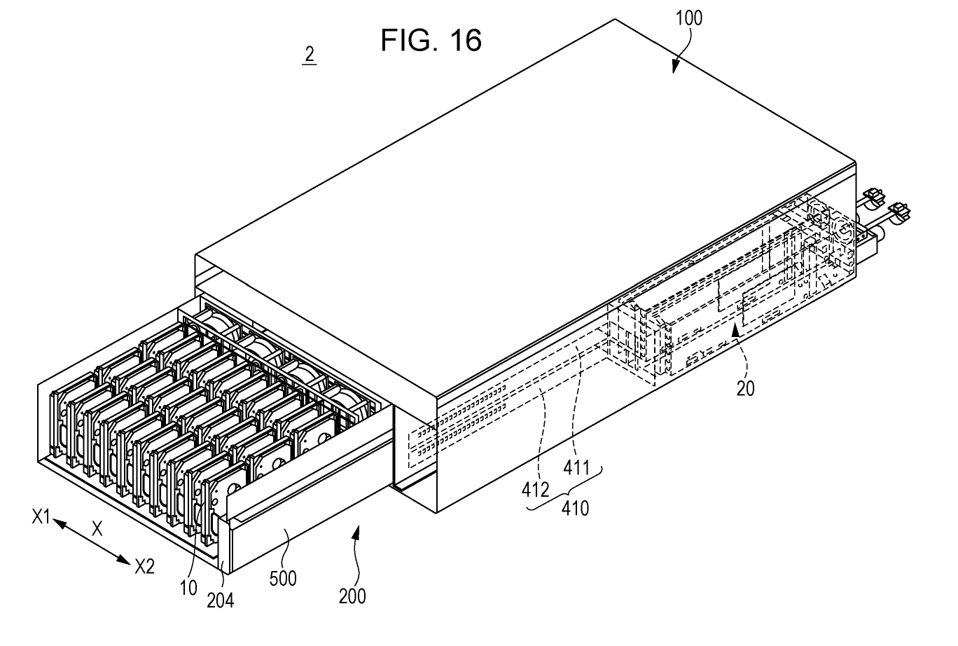

FIG. 15 is a perspective view illustrating a device 2 according to a second embodiment. FIG. 16 is a perspective view of the device 2 illustrated in FIG. 15 in which the tray 200 is drawn out.

The device 2 of the present embodiment is generally different in that the power supply system 300 of the device 1 according to the first embodiment described above is replaced with the power supply system 400. In other words, the device 2 of the present embodiment is generally different in that the first busbar 310, the second busbar 320, and the relay mechanism 330 of the device 1 according to the first embodiment described above are replaced with a first busbar 410, a second busbar 420, and a relay mechanism 430, respectively. Hereinafter, the configuration of the first busbar 410, the second busbar 420, and the relay mechanism 430 will be mainly described. Other components that may be similar to those described above in the first embodiment will be denoted with the same reference numerals and descriptions thereof will be omitted.

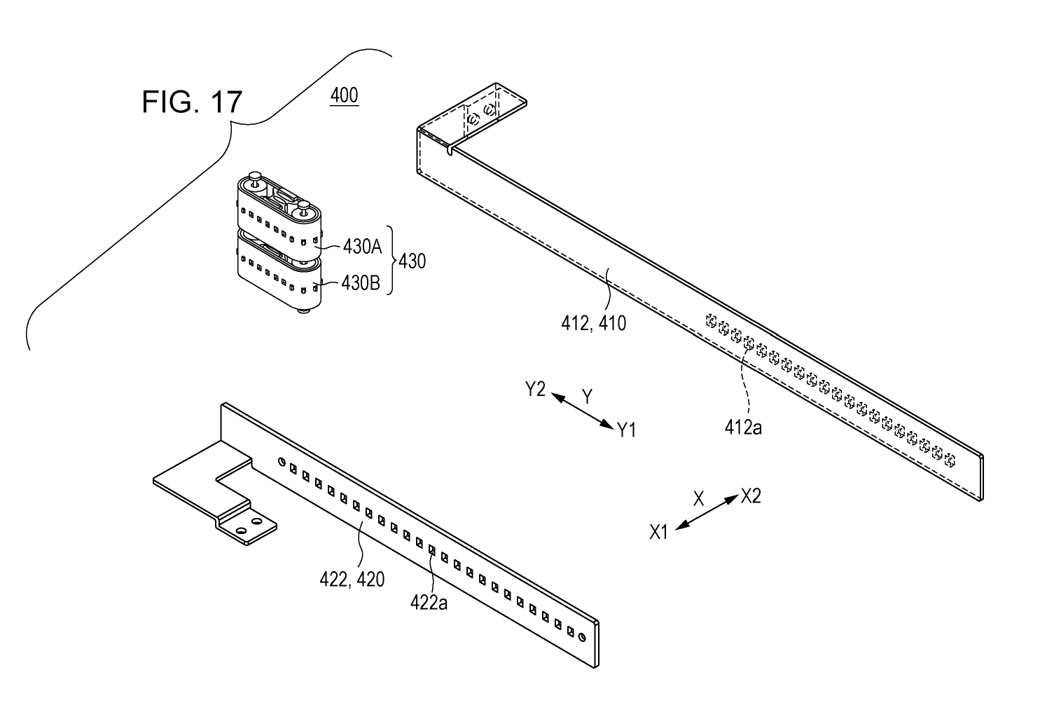

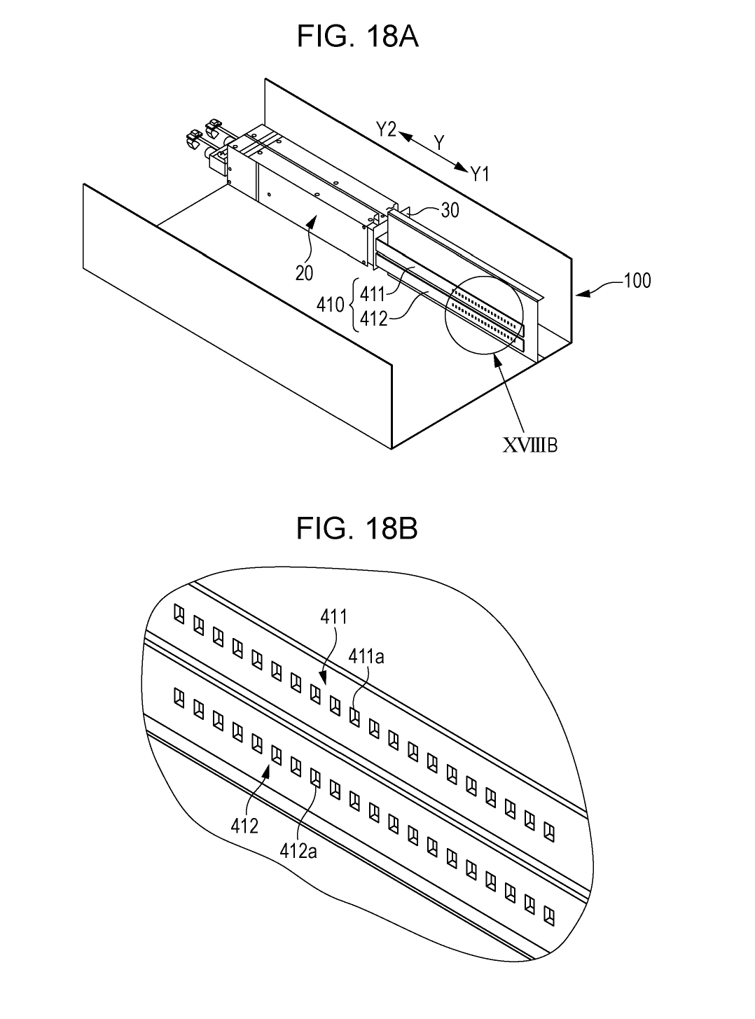

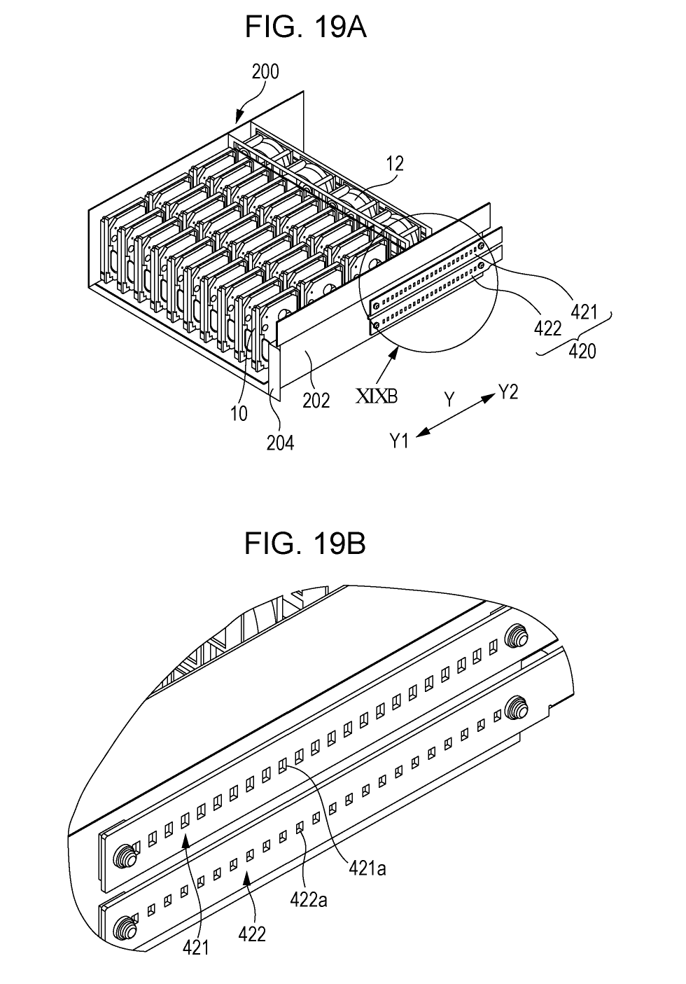

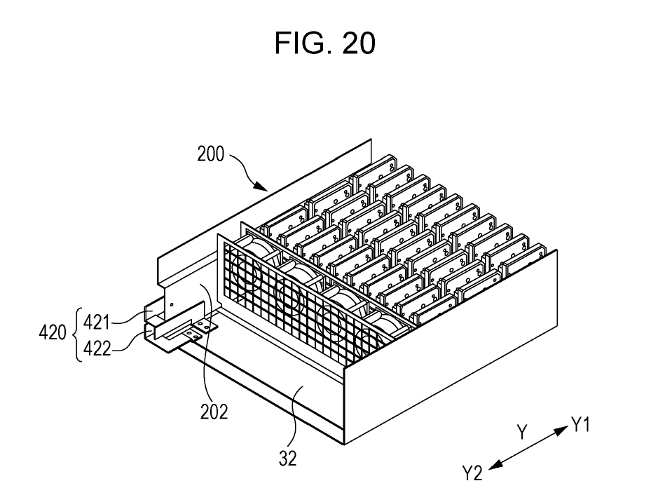

FIG. 17 is an exploded perspective view illustrating the power supply system 400 according to the second embodiment. FIGS. 18A and 18B are each a diagram illustrating an exemplary state in which the first busbar 410 is mounted in the housing 100. FIG. 18A is a general view and FIG. 18B is an enlarged view of portion XVIIIB. FIGS. 19A and 20 are each a perspective view illustrating an exemplary state in which the second busbar 420 is mounted to the tray 200. FIG. 19A is a perspective view seen from the front side and FIG. 20 is a perspective view seen from the rear side. FIG. 19A is a general view and FIG. 19B is an enlarged view of portion XIXB. Note that a portion of the first busbar 410 and a portion of the second busbar 420 (a first busbar 411 and a second busbar 421 on the upper side) are not shown in FIG. 17 in order to facilitate visual understanding. Furthermore, note that in FIG. 18A, in order to facilitate the view of the interior, illustration of the upper surface member of the housing 100 is omitted.

As illustrated in FIG. 17, the power supply system 400 includes the first busbar 410, the second busbar 420, and the relay mechanism 430.

In the second embodiment as well, similar to the first embodiment described above, the first busbar 410 includes the first busbar 411 on the upper side and a first busbar 412 on the lower side and the second busbar 420 includes the second busbar 421 on the upper side and a second busbar 422 on the lower side. Meanwhile, the relay mechanism 430 includes a relay mechanism 430A on the upper side and a relay mechanism 430B on the lower side in an integrated manner. However, similar to the first embodiment described above, the power supply system 400 may be provided with a mechanism that supplies the ground voltage and a mechanism that supplies the source voltage in a separate manner. Furthermore, the power supply system 400 may only include the mechanism that supplies the source voltage, and another component may be adopted as for the mechanism that supplies the ground voltage.

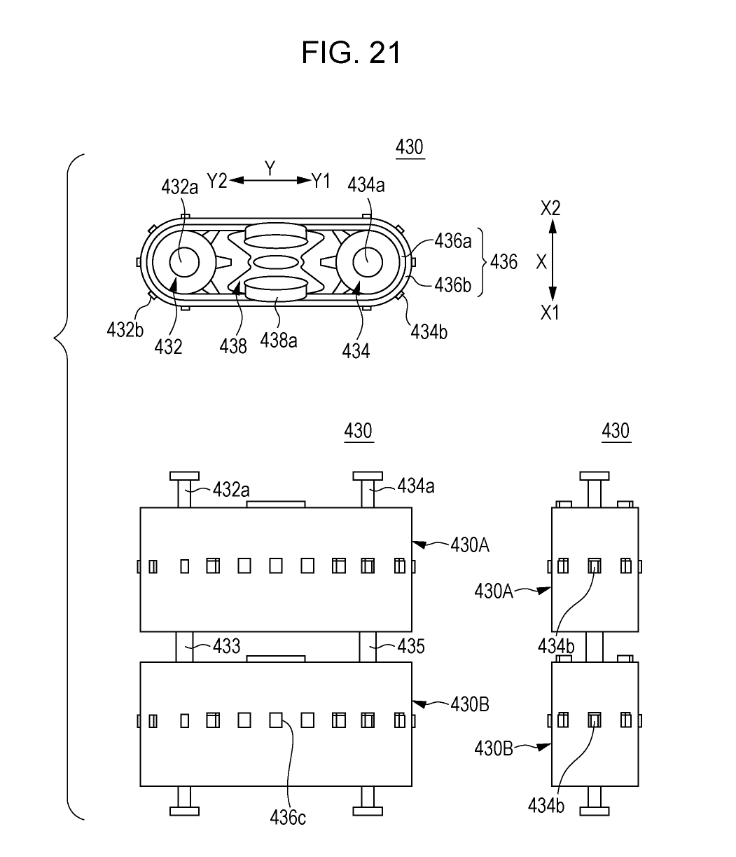

The first busbar 410 is different from the first busbar 310 according to the first embodiment described above in that a plurality of fitting holes 411a and 412a that are aligned with respect to one another in the Y direction are provided. Other configurations of the first busbar 410 may be similar to those of the first busbar 310 according to the first embodiment described above. As illustrated in FIGS. 18A and 18B, the plurality of fitting holes 411a are formed in the first busbar 411 on the upper side and the plurality of fitting holes 412a are formed in the first busbar 412 on the lower side. The spaces of the plurality of fitting holes 411a correspond to the spaces of a plurality of projections 432b (see FIG. 21) of the relay mechanism 430 that are described later and to the spaces of a plurality of projections 434b. The spaces of the plurality of fitting holes 412a correspond to the spaces of the plurality of projections 432b of the relay mechanism 430 that are described later and to the spaces of the plurality of projections 434b. Furthermore, the fitting holes 411a and 412a are formed at positions corresponding to the positions of the projections 432b and 434b in the Z direction.

The second busbar 420 is different from the second busbar 320 according to the first embodiment described above in that a plurality of fitting holes 421a and 422a that are aligned with respect to one another in the Y direction are provided. Other configurations of the second busbar 420 may be similar to those of the second busbar 320 according to the first embodiment described above. As illustrated in FIGS. 19A and 19B, the plurality of fitting holes 421a are formed in the second busbar 421 on the upper side and the plurality of fitting holes 422a are formed in the second busbar 422 on the lower side. The spaces of the plurality of fitting holes 421a correspond to the spaces of the plurality of projections 432b (see FIG. 21) of the relay mechanism 430 that are described later and to the spaces of the plurality of projections 434b. The spaces of the plurality of fitting holes 422a correspond to the spaces of the plurality of projections 432b of the relay mechanism 430 that are described later and to the spaces of the plurality of projections 434b. Furthermore, the fitting holes 421a and 422a are formed at positions corresponding to the positions of the projections 432b and 434b in the Z direction.

The relay mechanism 430 is provided between the first busbar 410 and the second busbar 420 and relays the electrical connection between the first busbar 410 and the second busbar 420. Note that similar to the relay mechanism 330 according to the first embodiment described above, as illustrated in FIG. 17, the relay mechanism 430 may include the relay mechanism 430A on the upper side and the relay mechanism 430B on the lower side. In a similar manner to the relay mechanism 330 according to the first embodiment described above, the relay mechanism 430 may be mounted in the housing 100 with the guide rails 120.

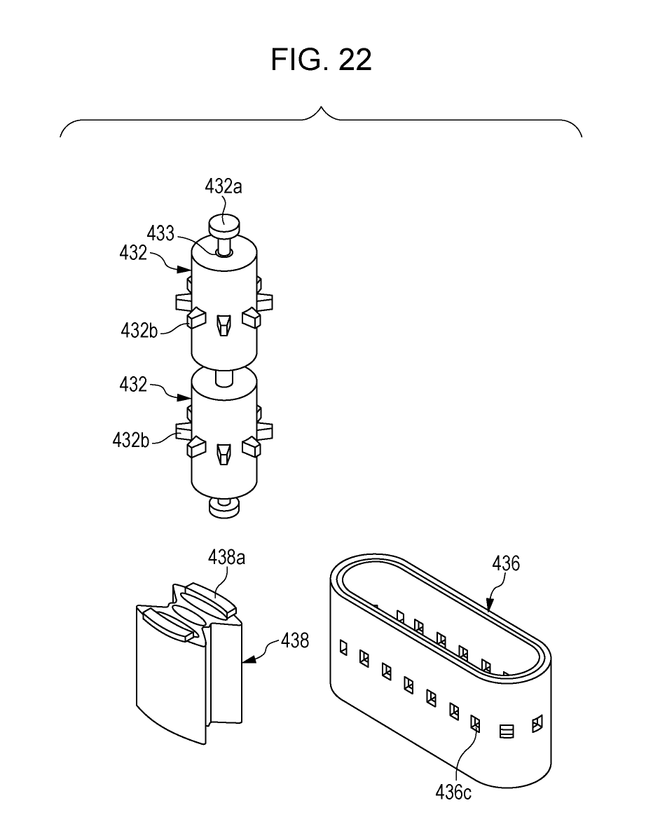

FIG. 21 illustrates three orthographic views of the relay mechanism 430. FIG. 22 is a perspective view of components of the relay mechanism 430 that have been picked out. Note that among first rollers 432 and second rollers 434, only the first rollers 432 are illustrated in FIG. 22 as a representative example. Note that in the present embodiment, the relay mechanism 430 includes the relay mechanism 430A on the upper side and the relay mechanism 430B on the lower side as described above and the components of the relay mechanism 430A and those of the relay mechanism 430B are basically the same and the same reference numerals are attached thereto.

The relay mechanism 430A includes the first roller 432, the second roller 434, and a belt 436. Furthermore, the relay mechanism 430A preferably includes an elastic member 438 as illustrated in FIG. 21. The relay mechanism 430B may have a similar configuration.

As illustrated in FIG. 22, the first rollers 432 are different from the first rollers 332 according to the first embodiment described above in that the plurality of projections 432b are provided on the outer peripheral surface of each of the first rollers 432 in the circumferential direction. Other configurations of the first rollers 432 may be similar to those of the first rollers 332 according to the first embodiment described above. The plurality of projections 432b may be formed on the whole circumference of each of the first rollers 432 in the circumferential direction at equal spaces. As described later, the plurality of projections 432b are formed with heights that allow the plurality of projections 432b to fit into the fitting holes 411a and 412a of the first busbar 410 and the fitting holes 421a and 422a of the second busbar 420. The plurality of projections 432b may be formed in the middle of each of the first rollers 432 in the axial direction (the Z direction). Note that a shaft portion 432a and a bearing 433 that rotatably support the first rollers 432 may have configurations similar to those of the shaft portion 332a and the bearing 333, respectively, according to the first embodiment described above.

As illustrated in FIG. 21, the second rollers 434 are different from the second rollers 334 according to the first embodiment described above in that the plurality of projections 434b are provided on the outer peripheral surface of each of the second rollers 434 in the circumferential direction. Other configurations of the second rollers 434 may be similar to those of the second rollers 334 according to the first embodiment described above. The plurality of projections 434b may be formed on the whole circumference of each of the second rollers 434 in the circumferential direction at equal spaces. As described later, the plurality of projections 434b are formed with heights that allow the plurality of projections 434b to fit into the fitting holes 411a and 412a of the first busbar 410 and the fitting holes 421a and 422a of the second busbar 420. The plurality of projections 434b may be formed in the middle of each of the second rollers 434 in the axial direction (the Z direction). Note that a shaft portion 434a and a bearing 435 that rotatably support the second rollers 434 may have configurations similar to those of the shaft portion 334a and the bearing 335, respectively, according to the first embodiment described above.

As illustrated in FIG. 22, the belts 436 are different from the belts 336 according to the first embodiment described above in that a plurality of through holes 436c are provided along the circumferential direction of each of the belts 436. Other configurations of the belts 436 may be similar to those of the belts 336 according to the first embodiment described above. The plurality of through holes 436c may be formed on the whole circumference of each of the belts 436 in the circumferential direction at equal spaces. The spaces of the plurality of through holes 436c correspond to the spaces of the plurality of projections 432b (the spaces in the circumferential direction) and to the spaces of the plurality of projections 434b (the spaces in the circumferential direction). The through holes 436c are formed at positions that correspond to the projections 432b of the first rollers 432 and the projections 434b of the second rollers 434 in the Z direction. The through holes 436c include openings that correspond to the projections 432b of the first rollers 432 and the projections 434b of the second rollers 434. In other words, the through holes 436c are formed so as to allow the projections 432b of the first rollers 432 and the projections 434b of the second rollers 434 to be inserted therein (to be passed therethrough). Note that in the second embodiment, the belts 436 are each provided with a double layer structure (a double structure) including a first belt 436a on the inner diameter side and a second belt 436b on the outer diameter side; however, each of the belts 436 may have a single layer structure similar to the structure of the belt 336 according to the first embodiment described above. On the other hand, each of the belts 336 according to the first embodiment described above may have a double layer structure similar to the structure of the belt 436. The first belts 436a may be formed of, for example, a conductive material such as copper or conductive rubber, and the second belts 436b may be formed of a copper thin plate.

Note that the belts 436 according to the second embodiment may, as described later, rotate around the first rollers 432 and the second rollers 434 while being rotated by the rotation of the first rollers 432 and the second rollers 434.

The elastic members 438 are components provided in the preferred embodiments in an optional manner and may be elastic members that are similar to the elastic members 338 according to the first embodiment described above. Note that in the second embodiment, the elastic members 438 each include supported portions 438a that are supported by the upper surface of the belt 436; however, the elastic members 438 may have a structure similar to the structure of the elastic members 338 according to the first embodiment described above. On the other hand, the elastic members 338 according to the first embodiment described above may each have supported portions similar to those of the elastic members 438.

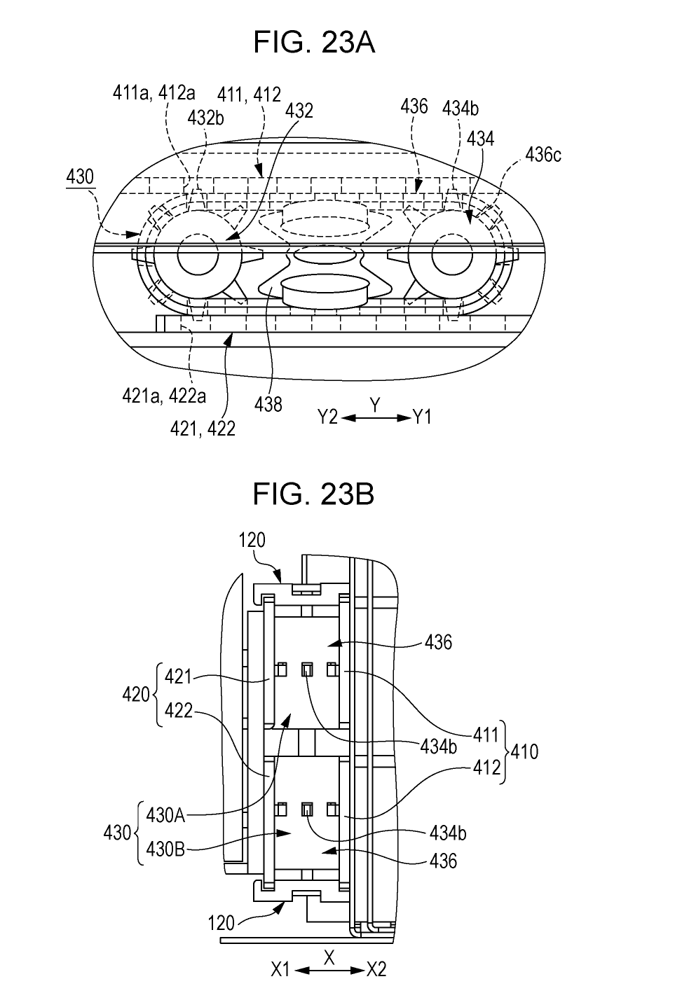

FIGS. 23A and 23B are each a diagram illustrating connection portions between the relay mechanism 430 and each of the first busbar 410 and the second busbar 420. FIG. 23A is a top view and FIG. 23B is a front view. Note that in FIGS. 23A and 23B, in order to facilitate the view of the interior, illustration of a protective cover 500 and a protective flange 204 of the tray 200 that are described later is omitted.

As illustrated in FIG. 23B, the relay mechanism 430 is disposed so that the belts 436 are in contact with both the first busbar 410 and the second busbar 420 in the X direction. In the above, as illustrated in FIG. 23A, the belts 436 are in surface contact with both the first busbar 410 and the second busbar 420. In other words, the belts 436 are in surface contact with both the first busbar 410 and the second busbar 420 at sections between the center of the first roller 432 and the center of the second roller 434 in the Y direction. Accordingly, the contact areas between the relay mechanism 430 and each of the first busbar 410 and the second busbar 420 may be increased in an efficient manner such that the relay mechanism 430 may relay electric power from the power source 20 to the tray 200 side in a stable and efficient manner. Note that each of the elastic members 438 preferably exerts an elastic force that reliably allows the relay mechanism 430 to come in contact with each of the first busbar 410 and the second busbar 420.

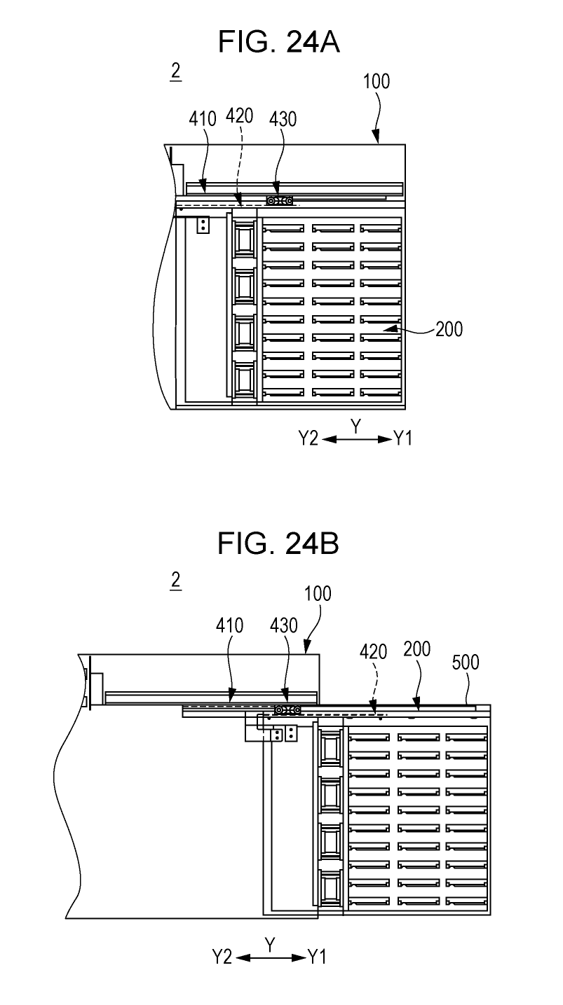

FIGS. 24A and 24B are each a top view illustrating the manner in which the relay mechanism 430 moves upon movement of the tray 200. FIG. 24A illustrates a state in which the tray 200 is housed in the housing 100 and FIG. 24B illustrates a state in which the tray 200 is drawn out from the housing 100. Note that in FIGS. 24A and 24B, in order to facilitate the view of the interior, illustration of the upper surface member of the housing 100 is omitted.

As illustrated in FIGS. 24A and 24B, when the tray 200 is drawn out from the housed state, the relay mechanism 430 moves in the Y2 direction with respect to the tray 200 and moves in the Y1 direction with respect to the housing 100. During the movement, the relay mechanism 430 maintains surface contact with the first busbar 410 and the second busbar 420. Note that during the storing operation as well, similar to the drawing-out operation, the relay mechanism 430 moves while maintaining surface contact with the first busbar 410 and the second busbar 420. During the movement of the relay mechanism 430, the belts 436 of the relay mechanism 430 rotate around the first rollers 432 and the second rollers 434 with the rotation of the first rollers 432 and the second rollers 434 (see FIG. 21). In other words, the belts 436 do not slide against the first busbar 410 and the second busbar 420 in the Y direction but rotates around the first rollers 432 and the second rollers 434 while relatively moving with respect to the first busbar 410 and the second busbar 420. Accordingly, the second embodiment may also obtain an effect similar to that obtained with the first embodiment described above.

In particular, in the second embodiment, the first rollers 432 and the second rollers 434 rotate while the projections 432b and 434b fit into the fitting holes 411a and 412a of the first busbar 410 and the fitting holes 421a and 422a of the second busbar 420. In other words, when the tray 200 moves in the Y1 direction, the second busbar 420 pushes the projections 432b and 434b that fit into the fitting holes 411a and 412a in the Y1 direction (the tangential direction). Furthermore, the first busbar 410 pushes the projections 432b and 434b that fit into the fitting holes 411a and 412a in the Y2 direction (the tangential direction). With the above, the first rollers 432 and the second rollers 434 are rotated in the counterclockwise direction in plan view. Consequently, the belts 436 are rotated in the counterclockwise direction in plan view with the projections 432b and 434b that penetrate the through holes 436c. In a similar manner, when the tray 200 moves in the Y2 direction, the second busbar 420 pushes the projections 432b and 434b that fit into the fitting holes 411a and 412a in the Y2 direction (the tangential direction). Furthermore, the first busbar 410 pushes the projections 432b and 434b that fit into the fitting holes 411a and 412a in the Y1 direction (the tangential direction). With the above, the first rollers 432 and the second rollers 434 are rotated in the clockwise direction in plan view. Consequently, the belts 436 are rotated in the clockwise direction in plan view with the projections 432b and 434b that penetrate the through holes 436c. As described above, in the second embodiment, the projections 432b and 434b, the through holes 436c, the fitting holes 411a and 412a, and the fitting holes 421a and 422a are provided in the above manner; accordingly, wear of the belts 436 and other components may be reduced in a further reliable manner. In other words, the possibility of the belts 436 sliding on the first busbar 410 and the second busbar 420 is reduced and the wear of the first busbar 410 and the second busbar 420 upon the drawing-out and storing operation of the tray 200 may be reduced in a further reliable manner.

Note that in the second embodiment, the projections 432b and 434b that are fitted into the fitting holes 411a and 412a of the first busbar 410 and the fitting holes 421a and 422a of the second busbar 420 are formed on each of the first rollers 432 and each of the second rollers 434. However, the above may be opposite. That is, fitting holes may be formed in the outer peripheral surfaces of the first rollers 432 and the outer peripheral surfaces of the second rollers 434, and projections may be formed on the first busbar 410 and the second busbar 420. In such a case, the projections of the first busbar 410 and the second busbar 420 may be fitted into the fitting holes of the first rollers 432 and the second rollers 434 through the through holes 436c of the belts 436.

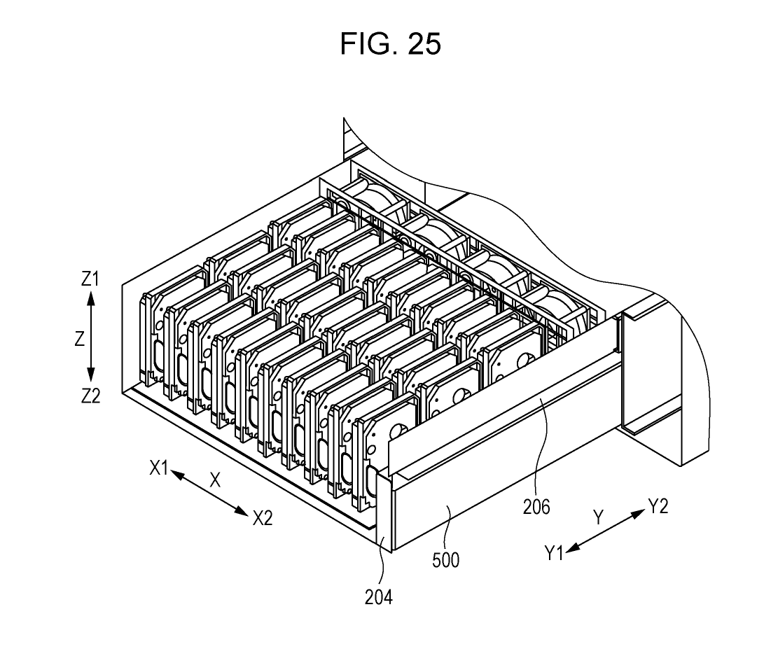

FIG. 25 is an explanatory drawing of the protective cover 500, the protective flange 204 of the tray 200, and other components and is an enlarged cut-away view of a portion of FIG. 16.

As illustrated in FIGS. 16 and 25, the device 2 preferably includes the protective cover 500. The protective cover 500 is provided to the tray 200 so as to cover the second busbar 420. In the example illustrated in FIG. 25, the protective cover 500 covers the second busbar 420 from the X2 side of the tray 200 in the X direction. Accordingly, when the tray 200 is drawn out from the housing 100, the second busbar 420, which is drawn out together with the tray 200, may be avoided from being exposed to the outside.

Note that as illustrated in FIG. 25, the protective cover 500 extends in the Y direction so that the whole exposed portion of the second busbar 420 is covered (hid) when the tray 200 is fully drawn out. In order to avoid the protective cover 500 from hindering the function of the relay mechanism 430 described above, the protective cover 500 may be provided on the X2 side with respect to the first busbar 410. The protective cover 500 may be fixed to the tray 200 with any method such as a screwing or the like. Note that in the example illustrated in FIG. 25, the upper side (the Z1 side) of the second busbar 420 is protected (covered) by a protective flange 206 on the upper side of the tray 200. In a similar manner, the lower side (the Z2 side) of the second busbar 420 may be protected by a protective flange (not shown) on the lower side of the tray 200. Furthermore, in the example illustrated in FIG. 25, the front side (the Y1 side) of the second busbar 420 is protected (covered) by the protective flange 204 on the front side of the tray 200. However, the protective cover 500 may be formed so as to carry out some or all of the functions of the protective flanges 204 and 206.

Note that the protective cover 500 may be provided to the device 1 according to the first embodiment described above in a similar manner.

Each of the embodiments has been described above in detail; however, the present disclosure is not limited to a specific embodiment and various modifications and changes may be made within the scope of the claims. Furthermore, all or some of the components of the embodiments described above may be combined with one another.

For example in the second embodiment described above, the projections 432b and 434b that are fitted into the fitting holes 411a and 412a of the first busbar 410 and the fitting holes 421a and 422a of the second busbar 420 are formed on each of the first rollers 432 and each of the second rollers 434. However, similar projections that fit into the fitting holes 411a and 412a and the fitting holes 421a and 422a may be formed in the outer peripheral surfaces of the belts 436. Alternatively, the fitting holes may be formed in the outer peripheral surfaces of the belts 436 and projections may be formed on the first busbar 410 and the second busbar 420. In either of the cases, the configurations of the first rollers 432 and the second rollers 434 may be similar to those of the first rollers 332 and the second rollers 334 according to the first embodiment described above. In such a case, similar to the first embodiment described above, the belts 436 rotate around the first rollers 432 and the second rollers 434 while the friction generated between the belts 436, and the first rollers 432 and the second rollers 434 rotates the first rollers 432 and the second rollers 434. Such friction between the belts 436, and the first rollers 432 and the second rollers 434 may be generated by engagement of the projections formed in or the fitting holes formed on the inner peripheral surfaces of the belts 436 and the fitting holes formed in or projections formed on the outer peripheral surfaces of the first rollers 432 and the second rollers 434.

Furthermore, in the second embodiment described above, the fitting holes 411a and 412a of the first busbar 410 and the fitting holes 421a and 422a of the second busbar 420 are holes that penetrate the first busbar 410 and the second busbar 420. However, the fitting holes 411a and 412a and the fitting holes 421a and 422a may be holes (concavities) with a bottom.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply system, comprising:
a first busbar provided to extend in a predetermined direction on a first member, the first busbar being conductive and supplied with electricity;
a second busbar provided to extend in the predetermined direction on a second member relatively movable with respect to the first member in the predetermined direction, the second busbar being conductive and spaced apart facing the first busbar;
two rollers provided between the first busbar and the second busbar facing each other, the two rollers being aligned with respect to each other in the predetermined direction; and
a belt configured to wind and rotate around the two rollers so as to contact with the first busbar and the second busbar with a surface contact thereof, the belt being conductive.

2. The power supply system according to claim 1, further comprising:
a pair of guide rails provided to the first member or the second member, the guide rails supporting shaft portions of the two rollers in a movable manner,
wherein the shaft portions of the two rollers move along the guide rails when the second member relatively moves with respect to the first member.

3. The power supply system according to claim 1, further comprising:
a third member provided between the two rollers, the third member pushing the belt towards both of the first busbar and the second busbar.

4. The power supply system according to claim 3, wherein the third member is elastic.

5. The power supply system according to claim 1, wherein the belt rotates around the two rollers without sliding with respect to the first busbar and the second busbar when the second member relatively moves with respect to the first member.

6. The power supply system according to claim 1, wherein
the two rollers include a plurality of projections provided on an outer peripheral surface and in a circumferential direction of the two rollers,
the belt includes a plurality of through holes through which the plurality of projections pass, and
the first busbar and the second busbar include a plurality of fitting holes into which the plurality of projections fit.

7. The power supply system according to claim 6, wherein
the plurality of projections are provided on the two rollers in the circumferential direction of the two rollers with a predetermined space,
the plurality of through holes of the belt are provided with a space corresponding to the predetermined space, and
the plurality of fitting holes are provided in the first busbar and the second busbar with a space corresponding to the predetermined space.

8. The power supply system according to claim 1, wherein
the second member is a tray capable of being drawn out and pushed in with translating to the first member, and
the second busbar is electrically connected with a hot-swap part provided on the tray.

9. The power supply system according to claim 1, wherein the belt is formed of a conductive rubber.

10. A rack mount apparatus, comprising:
a rack;
a first busbar provided to extend in a predetermined direction on a first member, the first busbar being conductive and supplied with electricity;
a tray capable of being drawn out and pushed in with translating to the first member in the predetermined direction;
a second busbar provided to extend in the predetermined direction on the tray, the second busbar being conductive and spaced apart facing the first busbar;
two rollers provided between the first busbar and the second busbar facing each other, the two rollers being aligned with respect to each other in the predetermined direction; and
a belt configured to wind and rotate around the two rollers so as to contact with the first busbar and the second busbar with a surface contact thereof, the belt being conductive,
wherein the second busbar is electrically connected with a hot-swap part provided on the tray.

11. The rack mount apparatus according to claim 10, further comprising:
a protective cover provided to the tray so as to cover the second busbar.
